(19) United States
(12) Patent Application Publication
(10) Pub. No.: US 2021/0331146 A1
(43) Pub. Date: Oct. 28, 2021

(54) Method Of Making Mono And Bimetallic Group V, VI And/Or Group VII Containing Carbides And Their Resulting Conversion Into Sulfides For Hydro Processing

(71) Applicant: ExxonMobil Research and Engineering Company, Annandale, NJ (US)

(72) Inventors: Yi Du, Coopersburg, PA (US); Bradley D. Wooler, Allentown, PA (US); Stuart L. Soled, Pittstown, NJ (US); Sabato Miseo, Pittstown, NJ (US); Christine E. Kliewer, Clinton, NJ (US)

(21) Appl. No.: 17/185,290

(22) Filed: Feb. 25, 2021

Related U.S. Application Data
(60) Provisional application No. 63/014,317, filed on Apr. 23, 2020.

(51) Int. Cl. B01J 27/22; B01J 21/08; B01J 35/00; B01J 37/02; B01J 37/08; C10G 45/08

(52) U.S. Cl. CPC B01J 27/22; B01J 21/08; B01J 35/0013; B01J 37/0203; B01J 37/084; C10G 2300/4018; C10G 45/08; C10G 2300/1055; C10G 2300/4006; C10G 2300/4012; C10G 2300/202; B01J 37/0205

(57) ABSTRACT

This application relates to preparation of mono and bimetallic group V, VI, and VII containing carbide catalysts and the methods of using the carbide catalysts in hydroprocessing applications. A method of producing a carbide catalyst comprising: depositing a precursor metal, an acid or an amine, and an organic compound on a support thereby forming an impregnated support, wherein the organic compound has a carbon number of 10 or greater; and carbonizing the impregnated support thereby forming a carbide phase on the support.

### FIELD

This application relates to preparation of mono and bimetallic group V, VI, and VII containing carbide catalysts and the methods of using the carbide catalysts in hydroprocessing applications.

### BACKGROUND

In hydroprocessing (HDP), a hydrocarbon feedstock is contacted with hydrogen in the presence of a hydroprocessing catalyst. Hydroprocessing may include hydrodesulfurization (HDS) and hydrodenitrogenation (HDN) whereby sulfur and nitrogen containing compounds in the hydrocarbon feedstock are reacted with the hydrogen in the presence of the hydroprocessing catalyst to produce hydrogen sulfide and nitrogen oxides. The hydrogen sulfide and nitrogen oxides may be separated from unreacted components of the hydrocarbon feedstock to produce a hydrocarbon stream with reduced concentrations of sulfur and nitrogen compounds. Other hydroprocessing reactions may include hydrodeoxygenation and saturation of olefins and aromatics. Typical hydroprocessing catalysts may include sulfided Group VI and Group VIII catalysts such as molybdenum disulfide. Hydroprocessing catalysts are often provided as Group VI and Group VIII oxide precursors which are subsequently sulfided in situ within a hydroprocessing reactor to the active sulfide catalyst.

Carbides may have pseudo metallic properties which may suitable to catalyze chemical reactions such as hydrodesulfurization (HDS) and hydrodenitrogenation (HDN) reactions. However, synthesis methods for carbide catalysts have hereto required reactive gasses such as CH₄ to be reacted with metals at relatively high temperatures, sometimes in excess of 700° C. Under such conditions, crystallites formed are relatively large and may have limited catalytically active surface area exposed. To convert the carbide to the active sulfided form, the carbides may be exposed to generalized sulfidation. However, the carbides formed may not be thermodynamically stable under sulfur rich environments which may pose challenges to converting the carbide catalyst to the active sulfided form. Additionally, high temperature carbide catalyst synthesis methods may produce relatively large carbide particle formation which in turn may produce relatively large active sulfided particles. The relatively large sulfided particles may have low catalyst activity as compared to HDP catalysts currently in use in industry thereby precluding the use of carbide catalysts in HDP applications.

### SUMMARY

This application relates to preparation of mono and bimetallic group V, VI, and VII containing carbide catalysts and the methods of using the carbide catalysts in hydroprocessing applications.

A method of producing a carbide catalyst may include: depositing a precursor metal, an acid or an amine, and an organic compound on a support thereby forming an impregnated support, wherein the organic compound has a carbon number of 10 or greater; and carbonizing the impregnated support thereby forming a carbide phase on the support.

A method may include: dissolving a first metal selected from group VI or group VIII and a second metal selected from cobalt or nickel in an acid or an amine to form a metal solution; depositing the metal solution on a support; depositing an organic compound on the support, wherein the organic compound has a carbon number of 10 or greater; and carbonizing the support thereby forming a carbide phase on the support.

A method of preparing nickel tungsten carbide may include: depositing nickel carbonate, tunstic acid, ethylenediamine, hydrophosphorous, and an organic compound with a carbon number of 10 or greater on a support forming an impregnated support; and carbonizing the impregnated support thereby forming a nickel tungsten carbide phase on the support.

A method may include: providing a reactor comprising a carbide catalyst, wherein the carbide catalyst comprises eta carbide; contacting the carbide catalyst with a sulfiding compound effective to covert the eta carbide to an active sulfided form thereby forming a sulfided catalyst; contacting a feed comprising nitrogen compounds, sulfur compounds, or both and a hydrogen feed with the sulfided catalyst at effective hydroprocessing conditions; and reacting at least a portion of the nitrogen compounds, sulfur compounds, or both with the hydrogen.

### BRIEF DESCRIPTION OF THE DRAWINGS

These drawings illustrate certain aspects of the present invention and should not be used to limit or define the invention.

FIG. 1 is a plot of results of an x-ray diffraction (XRD) test of carbides.

FIG. 2a is transmission electron micrograph of vanadium carbide.

FIG. 2b is a graph of particle size distribution of the vanadium carbide XRD of FIG. 2a.

FIG. 3 is a plot of results of an XRD test of carbides.

FIG. 4a is a plot of the result of the TGA-DTA analysis.

FIG. 4b is a plot of results of an XRD test of carbides.

FIG. 5 is a plot of results of an x-ray diffraction (XRD) test of carbides.

FIG. 6 is a transmission electron micrograph of cobalt molybdenum carbide.

FIG. 7 is results of an energy-dispersive X-ray spectroscopy test of cobalt molybdenum carbide.

FIG. 8 is a plot of results of an XRD test of carbides.

FIG. 9 is a plot of results of an XRD test of carbides.

FIG. 10 is a plot of results of an XRD test of carbides.

FIG. 11 is a plot of results of an XRD test of carbides.

FIG. 12 a is a micrograph of a carbide catalyst after hydroprocessing.

FIG. 12b is a graph of carbide layers on a carbide catalyst after hydroprocessing,

FIG. 13 is a plot of results of an XRD test of carbides.

FIG. 14 is a micrograph of a cobalt carbide.

FIG. 15 is a titration curve of carbon monoxide on cobalt carbide.

FIG. 16a is a plot of results of an XRD test of cobalt carbide after titration with carbon monoxide.

FIG. 16b is a plot of results of an XRD test of cobalt carbide after titration with carbon monoxide.

FIG. 16c is a plot of results of an XRD test of cobalt carbide after titration with carbon monoxide.

FIG. 17 is a plot of results of an XRD test of carbides.

### DETAILED DESCRIPTION

This application relates to preparation of mono and bi metallic group V, VI, VII, and VIII carbide catalysts. The application further relates to using the carbide catalysts in hydroprocessing applications. While the carbide catalysts of the present disclosure may be suitable for use in a standalone unit, the compositions and methods disclosed herein may be particularly suitable for integrated hydroprocessing applications within petroleum refineries and chemical plants. There may be several potential advantages to the compositions and methods disclosed herein, only some of which may be alluded to in the present disclosure. One of the many potential advantages of the compositions and methods herein is that carbide catalysts may provide higher catalytic activity than HDP catalysts presently in use.

Transition metal carbides and nitrides can be visualized as close packed metals with carbon or nitrogen atoms located in some of the interstitial holes of the metal. Carbides may have substantially different physical, chemical, and electronic properties as compared to the base metal the carbide is derived from. The disparate properties of carbides may also affect the types of reactions which the carbide can participate in, including catalyzing reactions. Some of the bimetallic carbides of the present application may form a unique carbide phase referred to as eta carbide phase, eta carbide, or η-carbide. Eta carbides are carbon deficient which yields unique physical and chemical properties. Eta carbides may be stable to high temperatures (1000°+) and do not experience phase separation at these elevated temperatures. The eta carbide phases contain the elements suitable for catalyzing hydroprocessing reaction, however, the elements are present in different ratios than traditional hydroprocessing catalysts. Eta carbides may contain group VI and VIII elements in molar ratios of approximately 1:1.

The general process for preparation of carbide catalysts of the present application may include dissolving a precursor metal with an amine or acid followed by incipient wetness impregnation on a support. Thereafter, a long chain organic such as an acid if the preceding step used an amine and a base if the preceding step used an acid may be added to the support using incipient wetness impregnation. The support may then be carbonized under inert atmosphere which may form carbide phases on the support. The support containing carbide phases may then be subjected to generalized pre-sulfidation to convert the carbides to sulfides as the active catalytic phase. As will be discussed in detail below, the carbides produced by the methods disclosed herein are unique in that a majority of carbide particles formed are less than 2 nm as measured on a major axis and after sulfidation, a majority of the sulfide phases comprise single stack layers. Further, the carbide particles formed are well dispersed across the support. These and other properties of the produced carbides may contribute to the catalytic activity of the carbides in hydroprocessing applications. It is believed that the amine or acid in combination with the long chain organic forms a complex which slowly decomposes under heat and inert atmosphere to allow the carbide phase to form slowly thereby limiting particle size and contributing to the dispersion of the carbide phase across the support.

The support may include and suitable catalyst supports such as silica (SiO₂), alumina (Al₂O₃), aluminosilicates, magnesia, titania, tungsten oxide (WO₃), zirconium oxide (ZrO₂), tungsten oxide/zirconium oxide (WO₃/ZrO₂), acidic clay, silicoaluminophosphates (SAPO), and combinations thereof. The support may be solid or porous and may have any suitable surface area for hydrotreating applications. For example, the support may have a surface area in the range of from about 10 to about 1000 m²/g, pore volume in a range of from about 0.1 to about 4.0 cc/g, and average particle size in a range of from about 10 to about 500 μm. In some examples, the support surface area may have a surface area in a range of from about 50 to about 500 m²/g, pore volume in a range of from about 0.5 to about 3.5 cc/g, and average particle size in a range of from about 20 to about 200 μm. Still further, the support may have a surface area in the range of from about 100 to about 400 m²/g, pore volume in a range of from about 0.8 to about 3.0 cc/g and average particle size may range from about 20 to about 100 μm, or any ranges there between.

The precursor metal may be selected from group V, VI, VII, and VIII of the periodic table. Some exemplary metals may include vanadium, niobium, tantalum, chromium, molybdenum, tungsten, manganese, technetium, rhenium, iron, ruthenium, rhodium, and combinations thereof. While the precursor metal may be provided in the metallic form, it may be advantageous to provide the group V, VI, VII, and VIII metal in an oxide form, an acid form, a hydroxide form, or a carbonate form. Some exemplary precursor metals may include, without limitation, vanadium oxide (V₂O₅), manganese oxide (MnO, Mn₃O₄, Mn₂O₃), niobium pentoxide (Nb₂O₅), niobic acid (Nb₂O₅.nH₂O), tungsten oxide (W₂O₃, WO₂, WO₃, W₂O₅), tungstic acid monohydrate (WO₃.H₂O) and tungstic acid hemihydrate (WO₃0.5H₂O), ammonium metatungstate hydrate ((NH₄)₆H₂W₁₂O₄₀ xH₂O), molybdenum trioxide (MoO₃), molybdenum acid monohydrate (MoO₃.H₂O) and molybdenum acid monohydrate dihydrate (MoO₃.2H₂O). In some examples, the precursor metal may further include nickel and/or cobalt compounds. In such examples, the nickel or cobalt may be sourced from any of NiCO3, CoCO3, Ni(NO3)2, Co(NO3)2, Ni(OH)2, and Co(OH)2, for example. The precursor metal may be included in the carbide catalyst in any amount including from about 0.1 wt. % to about 70 wt. % of the carbide catalyst. Alternatively, the precursor metal may be present in an amount of about 0.1 wt. % to about 10 wt. %, or about 10 wt. % to about 20 wt. %, or about 20 wt. % to about 30 wt. %, or about 40 wt. % to about 50 wt. %, or about 50 wt. % to about 60 wt. %, about 60 wt. % to about 70 wt. %, or any ranges therebetween.

Examples of the carbide catalyst may include mono and bi metallic varieties. Monometallic carbides (MCx) may include one metal selected from group V, VI, VII, or VIII and carbon. The notation MCx is used as shorthand to identify the metal (M) included in the carbide (Cx) where Cx is non-specific to stoichiometry. Some examples of monometallic carbides include vanadium carbide (VCx), niobium carbide (NbCx), and tungsten carbide (WCx).

Bimetallic carbides may be of the form (M₁M₂Cx) where M₁ and M₂ are metals are individually selected from group V, VI, VII, and VIII and carbide (Cx) where Cx is non-specific to stoichiometry. Bimetallic carbides (M₁M₂Cx) may have a molar ratio of M₁ to M₂ of about 0.5:1 to about 2:1. Alternatively, Bimetallic (M₁M₂Cx) may have a molar ratio of M₁ to M₂ of about 0.5:1 to about 1:1, about 1:1 to about 1.5:1, about 1:5:1 to about 2:1, or any ranges therebetween. Bimetallic carbides may also be synthesized to include an eta carbide phase. In eta phase examples, M₁ is selected from group VI or VIII and M₂ is selected from Co or Ni and the molar ratio of M₁ to M₂ is about 1:1. Some examples of bimetallic carbides include cobalt tungsten carbide (CoWCx), cobalt molybdenum carbide (CoMoCx), and nickel tungsten carbide (NiWCx).

As mentioned above, the precursor metal or metals, may be dissolved in an amine or an acid prior to incipient wetness deposition onto the support. The amine or acid may be, for example a primary amine or a carboxylic acid. In some examples the acid or amine may have chelating properties which may at least partially chelate the precursor metal or metals to form a metal complex in solution. Some example acids or amines may include, without limitation, ethylenediamine, citric acid, malic acid, 2-(2-aminoethylamino) ethanol, 1,2 diamine cyclohexane, and combinations thereof. The acid or amine may be used in any molar ratio with the precursor metal such as in a molar ratio of about 1:1 to about 1:10 precursor metal to acid or amine. Alternatively the acid or amine may be present in a molar ratio of about 1:1 to about 1:3 precursor metal to acid or amine, about 1:3 to about 1:5 precursor metal to acid or amine, about 1:5 to about 1:8 precursor metal to acid or amine, about 1:8 to about 1:10 precursor metal to acid or amine, or any ranges therebetween.

As mentioned above, a long chain organic may be included in preparations of the carbide catalysts. The long chain organic may form a complex with the acid or amine used in the previous step to dissolve the precursor metal which may stabilize the carbide during the step of carbide catalyst preparation. Further, the long chain organic may be a source of carbon during the carbonization step of carbide catalyst preparation. Long chain organics may degrade slowly during the carbonization phase which may promote smaller carbide particle sizes to form. The long chain may include any long chain organic with carbon numbers from C10 to C24 and may include functional groups such as carboxylic acid, amine, alcohol, phosphate, acrylate, and ketone for example. In some examples, the long chain organic may be a long chain fatty acid or long chain fatty amine with carbon numbers from C10 to C24. Some examples of long chain organics may include, without limitation, oleylamine, oleic acid, and combinations thereof. The long chain organic may be selected such that the long chain organic has an opposite change of the amine or acid selected to dissolve the precursor metal or metals. For example, if an acid is selected to dissolve the precursor metal, then a long chain organic comprising an amine may be selected. Alternatively, if an amine is selected to dissolve the precursor metal, the long chain organic comprising a carboxylic acid may be selected. The long chain organic may be used in any molar ratio with the precursor metal such as in a molar ratio of about 1:1 to about 1:10 precursor metal to long chain organic. Alternatively the long chain organic may be present in a molar ratio of about 1:1 to about 1:3 precursor metal to long chain organic, about 1:3 to about 1:5 precursor metal to long chain organic, about 1:5 to about 1:8 precursor metal to long chain organic, about 1:8 to about 1:10 precursor metal to long chain organic, or any ranges therebetween. In some examples, the long chain organic may be diluted with a carrier fluid before deposition onto the support. For example, the long chain organic may be diluted with a simple alkane such as hexane, cyclohexane, heptane, octane, or any isomers thereof.

Methods of preparing the carbide catalysts may include depositing the precursor metal(s), promoter, if present, dissolved in amine or an acid to a support, depositing a long chain organic on the support, and carbonizing the impregnated support under inert atmosphere. Previous methods of preparing carbides generally require a carbon atmosphere as a source of carbon whereas the present methods utilize the long chain organic as a source of carbon. Thus, the inert atmosphere may be free of or contain less than about 50 ppm of carbon containing gasses, including, but not limited to methane, CO, and CO2. The step of carbonizing may be carried out in any suitable reactor, such as a tube furnace, for example. Carbonizing may be carried out at any suitable temperature to form the eta phase carbide. The transition temperature required for conversion of the metal precursor to carbide may be dependent upon the composition and chemical identity of the metal precursor, so the carbonization should be carried out at a temperature at or above the transition temperature for the carbide. For example, the carbonizing may be carried out at a temperature in a range of about 350° C. to about 1000° C. Alternatively, the carbonizing may be carried out at a temperature in a range of about 350° C. to about 450° C., about 550° C. to about 550° C., about 550° C. to about 650° C., about 50° C. to about 750° C., about 750° C. to about 850° C., about 850° C. to about 100, or any ranges there between. The carbonizing may be carried out for any length of time required to convert the metal precursor to the carbide phase. For example, the impregnated support may be heated in the reactor for a period of minutes to days to convert the metal precursor to the eta carbide form. Without limitation, the carbonizing may be carried out for about 30 minutes, about one hour, about five hour, about one day, or any ranges there between. The carbides produced by the above methods may be sensitive to oxygen at elevated temperatures and may revert to the oxide form if exposed to oxygen while at elevated temperatures. The method may further include progressively cooling the carbides using an inert gas stream such as nitrogen, helium, noble gasses, or combinations thereof after carbonization to slowly cool the carbides without exposing the carbide to oxygen.

Carbides produced by the above methods may have unique physical properties as compared to carbides produced by disparate methods. For example, the carbides produced by the above method may have a majority of carbide particles monodispersed in a single layer across the support. Carbides produced may have, for example, greater than 50% by number of particulates monodispersed, greater than 75% by number of particulates monodispersed, greater than 90% by number of particulates monodispersed, or any points therebetween. Further, the carbides produced may have smaller average particle sizes as compared to carbides produced by disparate methods. Carbides produced may have a measured particle size on a major axis of less than 2 nm, as measured by transmission electron microscopy. In some examples, the carbides may have an average particle size of 1.5 nm or less or 1 nm or less. Carbides produced by the above methods may have a majority of the carbide phase present as eta carbide. For example, the carbides may have eta carbide phase of 50 wt. % or greater, 75 wt. % or greater, 90% or greater, 95% or greater, or any values therebetween.

After the carbide catalysts have been synthesized, the carbide catalysts may be converted to the active sulfide form by sulfidation. The carbide catalysts may be exposed to sulfur under conditions effective to convert the carbide phase to the corresponding sulfided phase such as by liquid or gaseous sulfurization conditions. In laboratory scale, an example method for gaseous sulfidation may include placing dried or calcined carbide catalyst in an inert container such as a quartz boat which may be in turn inserted into a horizontal quartz tube and placed into a Lindberg furnace. While still at room temperature, a flow of 240 cm3/min of 10% H2S/H2 may be admitted for 15 minutes, and then the temperature may be raised to a nominal 400° C. in 45 minutes with 10% H2S/H2 flowing at 240 cm3/min. The flow of H2S/H2 may be continued for 2 hours at 400° C. The sample may be cooled in flowing 10% H2S/H2 to room temperature and held at room temperature for 30 minutes at the same flow. Thereafter, the sample may be purged with 300 cm3/min of flowing N2 for 30 minutes. A 1% O2 in Ar passivation gas may be introduced at 50 cm3/min at room temperature and passed over the catalyst overnight.

A laboratory method for liquid sulfidation will may include preparing a reactor by adding carbide catalyst to a continuously stirred reactor. H2 flowing at 50 cc/min may be added to the reactor and the temperature may be raised to 100° C. At 100° C., the pressure may be maintained at 100 psig and H2 flow may be stopped. A sulfiding feed (7.5 wt % of dimethyl disulfide dissolved in a diesel feed) may be introduced to the reactor at 8 ml/h and be contracted with the carbide catalyst for 4 hours. Then, with the sulfiding feed continuing, 24 l/hr H2 may be added to the reactor and the pressure may be raised to 41.4 bar. The temperature may be increased to 200° C. over 1.5 hours, and then to 235° C. over 2 hours. The reactor may be held isothermal at 235° C. for 16 hours. Following the isothermal hold, the temperature may be raised to 290° C. over a period of 10 hours, then may be raised to 340° C. over 2 hours and held isothermal for 10 hours. While the laboratory sulfidation conditions may be suitable to convert relatively smaller amounts of the carbide phase to the corresponding sulfided phase, sulfidation conditions and procedures for production scale reactors may differ from the laboratory conditions described herein. In general, sulfidation may include loading a reactor with the carbide catalyst and exposing the carbide catalyst to a sulfur source at conditions effective to convert at least a portion of the carbide catalyst to the corresponding sulfided phase.

As discussed above, the carbide catalyst may be particularly suitable for use in hydroprocessing applications. Hydroprocessing generally includes contacting a hydrocarbon feed with hydrogen in the presence of a catalytically effective amount of a bulk catalyst under catalyst conversion conditions. Hydroprocessing may include processes such as the hydroconversion of heavy petroleum feedstocks to lower boiling products, hydrocracking of distillate boiling range feedstocks, hydrotreating of various petroleum feedstocks to remove heteroatoms, such as sulfur, nitrogen, and oxygen, hydrogenation of unsaturated hydrocarbons, hydroisomerization and/or catalytic dewaxing of waxes such as Fischer-Tropsch waxes, demetallation of heavy hydrocarbons, and ring-opening, for example. Catalyst conversion conditions are considered those conditions that when selected achieve the desired result of the hydroprocessing process. For example, effective catalyst conversion conditions for nitrogen and sulfur removal are to be considered those conditions that, when selected, achieve the desired degree nitrogen and sulfur removal to produce the desired product.

The carbide catalysts of the present application may be effective for hydroprocessing where the removal of nitrogen and sulfur from the hydrocarbon feed is desired and may be particularly effective for hydroprocessing feeds containing both nitrogen and sulfur. The contacting of the hydrocarbon feed with the carbide catalyst occurs in the presence of a hydrogen-containing treat gas, and the reaction stage is operated under effective hydroprocessing conditions. The contacting of the hydrocarbon feed with the carbide catalyst produces at least a hydrocarbon product having less nitrogen, sulfur, or both compared to the hydrocarbon feed.

The hydrocarbon feed may be a material that contains hydrogen and carbon which may obtained or derived from crude petroleum oil, from tar sands, from coal liquefaction, shale oil, or hydrocarbon synthesis. The hydrocarbon feed may also be sourced from refinery units such as atmospheric distillation, vacuum distillation, or other refinery units that contain sulfur or nitrogen. Hydrocarbon feeds may include feeds boiling from the naphtha boiling range to heavy feedstocks such as those with a boiling from about 40° C. to about 1000° C. at atmospheric pressure. Examples of hydrocarbon feeds may include, without limitation, vacuum gas oils, distillates including naphtha, diesel, kerosene, jet fuel, heavy gas oils, raffinates, lube oils, cycle oils, waxy oils, and combinations thereof.

Hydrocarbon feeds may contain contaminants such as nitrogen and sulfur. Nitrogen and sulfur are typically not found as free nitrogen and sulfur but are rather found as carbon-nitrogen and carbon-sulfur compounds in the hydrocarbon feed. Nitrogen content may range from about 0 wppm to about 5000 wppm nitrogen, based on the weight of the feed, or about 75 wppm to about 800 wppm nitrogen, or about 100 wppm to about 700 wppm nitrogen. Nitrogen may be present as both basic and non-basic nitrogen species. Examples of basic nitrogen species include quinolines and substituted quinolines, and examples of non-basic nitrogen species may include carbazoles and substituted carbazoles.

Hydrocarbon feed sulfur content may range from about 0 wppm to about 3000 wppm by weight the feed. Alternatively, sulfur may be present in an amount of about 0 wppm to about 50 wppm based on the weight of the feed, or from about 100 wppm to about 5000 wppm, or from about 100 wppm to about 3000 wppm. Feeds subjected to prior processing such as separation, extraction, hydroprocessing, etc., may have significantly less sulfur, for example in the range of 75 wppm to 500 wppm. Feed sulfur will usually be present as organically bound sulfur. That is, as sulfur compounds such as simple aliphatic, naphthenic, and aromatic mercaptans, sulfides, di- and polysulfides and the like. Other organically bound sulfur compounds include the class of heterocyclic sulfur compounds such as thiophene, tetrahydrothiophene, benzothiophene and their higher homologs and analogs.

Hydroprocessing uses hydrogen or a hydrogen-containing treat gas. Treat gas can comprise substantially pure hydrogen or can be mixtures of other components typically found in refinery hydrogen streams. It is preferred that the treat gas contain little, more preferably no, hydrogen sulfide. The treat gas purity may be at least about 50% by volume hydrogen, about 75% by volume hydrogen, or greater than 90% by volume hydrogen. The treat gas can be pure or substantially pure hydrogen.

Accordingly, the preceding description describes preparation of mono and bimetallic group V, VI, and VII containing carbide catalysts and the methods of using the carbide catalysts in hydroprocessing applications. The systems and methods disclosed herein may include any of the various features disclosed herein, including one or more of the following embodiments.

Embodiment 1. A method of producing a carbide catalyst comprising: depositing a precursor metal, an acid and/or an amine, and an organic compound on a support thereby forming an impregnated support, wherein the organic compound has a carbon number of 10 or greater; and carbonizing the impregnated support thereby forming a carbide phase on the support.

Embodiment 2. The method of embodiment 1 wherein the precursor metal is selected from the group consisting of a group V metal, a group VI metal, a group VII metal, a group VIII metal, nickel, cobalt, and combinations thereof.

Embodiment 3. The method of any of embodiments 1-2 wherein the precursor metal is at least one of vanadium oxide (V₂O₅), manganese oxide (MnO, Mn₃O₄, Mn₂O₃), niobium pentoxide (Nb₂O₅), niobic acid (Nb₂O₅.nH₂O), tungsten oxide (W₂O₃, WO₂, WO₃, W₂O₅), tungstic acid monohydrate (WO₃.H₂O), tungstic acid hemihydrate (WO₃.0.5H₂O), ammonium metatungstate hydrate ((NH₄)₆H₂W₁₂O₄₀ xH₂O), molybdenum trioxide (MoO₃), molybdenum acid monohydrate (MoO₃.H₂O), molybdenum acid monohydrate dihydrate (MoO₃.2H₂O), or combinations thereof.

Embodiment 4. The method of any of embodiments 1-3 wherein the precursor metal comprises a first metal selected from a group VI metal or a group VIII metal and a second metal selected from cobalt or nickel and wherein the carbide phase formed comprises eta carbide.

Embodiment 5. The method of embodiment 4 wherein the eta carbide phase comprises particles of eta carbide, wherein 50 wt. % or greater of the particles of eta carbide comprise particle sizes of less than 2 nm, and wherein 50% or more of the particles of eta carbide are monodispersed.

Embodiment 6. The method of any of embodiments 1-5 wherein the carbide catalyst is a bimetallic carbide of the form of (M₁M₂Cx) where M₁ and M₂ are metals are individually selected from group V, VI, VII, and VIII and Cx is carbon wherein M₁ and M₂ are present in a molar ratio of about 0.5:1 to about 1:1.

Embodiment 7. The method of any of embodiments 1-6 wherein the acid or amine is selected from the group consisting of ethylenediamine, citric acid, malic acid, 2-(2-aminoethylamino) ethanol, 1,2 diamine cyclohexane, and combinations thereof.

Embodiment 8. The method of any of embodiments 1-7 wherein the organic compound comprises at least one functional group selected from the group consisting of carboxylic acid, amine, alcohol, phosphate, acrylate, ketone, and combinations thereof.

Embodiment 9. The method of any of embodiments 1-8 wherein the organic compound is a long chain fatty acid or fatty amine with carbon numbers from C10 to C24.

Embodiment 10. The method of any of embodiments 1-9 wherein the support is selected from the group consisting of silica (SiO₂), alumina (Al₂O₃), aluminosilicates, magnesia, titania, tungsten oxide (WO3), zirconium oxide (ZrO₂), tungsten oxide/zirconium oxide (WO3/ZrO₂), acidic clay, silicoaluminophosphates (SAPO), and combinations thereof.

Embodiment 11. The method of any of embodiments 1-10 wherein the step of depositing comprises depositing using incipient wetness.

Embodiment 12. The method of any of embodiments 1-11 wherein the step of carbonizing comprises heating the impregnated support at a temperature in a range of about 350° C. to about 1000° C. in an inert atmosphere.

Embodiment 13. The method of embodiment 12 wherein the inert atmosphere is free of methane, CO, and CO2.

Embodiment 14. A method comprising: dissolving a first metal selected from group VI or group VIII and a second metal selected from cobalt or nickel in an acid or an amine to form a metal solution; depositing the metal solution on a support; depositing an organic compound on the support, wherein the organic compound has a carbon number of 10 or greater; and carbonizing the support thereby forming a carbide phase on the support.

Embodiment 15. The method of embodiment 14 wherein the acid or amine at least partially chelate the first metal, the second metal, or both.

Embodiment 16. The method of any of embodiments 14-15 wherein the acid or amine is selected from the group consisting of ethylenediamine, citric acid, malic acid, 2-(2-aminoethylamino) ethanol, 1,2 diamine cyclohexane, and combinations thereof.

Embodiment 17. The method of any of embodiments 14-16 wherein the organic compound comprises at least one functional group selected from the group consisting of carboxylic acid, amine, alcohol, phosphate, acrylate, ketone, and combinations thereof and wherein the organic compound has a carbon number from C10 to C24.

Embodiment 18. A method of preparing nickel tungsten carbide comprising: depositing nickel carbonate, tunstic acid, ethylenediamine, hydrophosphorous, and an organic compound with a carbon number of 10 or greater on a support forming an impregnated support; and carbonizing the impregnated support thereby forming a nickel tungsten carbide phase on the support.

Embodiment 19. The method of embodiment 18 wherein the organic compound comprises at least one functional group selected from the group consisting of carboxylic acid, amine, alcohol, phosphate, acrylate, ketone, and combinations thereof and wherein the organic compound has a carbon number from C10 to C24.

Embodiment 20. A method comprising: providing a reactor comprising a carbide catalyst, wherein the carbide catalyst comprises eta carbide; contacting the carbide catalyst with a sulfiding compound effective to covert the eta carbide to an active sulfided form thereby forming a sulfided catalyst; contacting a feed comprising nitrogen compounds, sulfur compounds, or both and a hydrogen feed with the sulfided catalyst at effective hydroprocessing conditions; and reacting at least a portion of the nitrogen compounds, sulfur compounds, or both with the hydrogen.

Embodiment 21. The method of embodiment 20 wherein the carbide catalyst comprises eta phase carbide particulates disposed on a support, wherein 50 wt. % or greater of the particles eta phase carbide comprise particle sizes of less than 2 nm, and wherein 50% or more of the eta phase carbide are monodispersed.

Embodiment 22. The method of any of embodiments 20-21 wherein the carbide catalyst comprises a first metal selected from a group VI metal or a group VIII metal and a second metal selected from cobalt or nickel.

### EXAMPLES

To facilitate a better understanding of the present invention, the following examples of certain aspects of some embodiments are given. In no way should the following examples be read to limit, or define, the entire scope of the invention.

### Example 1

Vanadium carbide (VCx) was prepared by adding 9.09 g vanadium oxide (V₂O₅) to 30 ml water, followed by the addition of 18.03 g ethylenediamine (en) solution. The vanadium oxide ethylenediamine solution was deposited on 40 g silica gel (SiO₂) at 100° C. using incipient wetness impregnation to 18.5 wt. % V₂O₅ loading. The impregnated silica was spread in a thin layer to dry at 100° C. overnight. Dilute 28.25 g oleic acid (ol) was added to 11.75 mL heptane and the solution was impregnated onto the silica and then dried at 100° C. The silica containing oleic acid and vanadium oxide were then heated at 3° C./min to 750° C. under N₂ in a tube furnace and held at 750° C. for 2 hours. Thereafter, the furnace was then shut off and cooled to room temperature under N₂. The tube furnace was then purged with N₂, followed by a diluted stream of O₂ in He before silica was removed from the furnace. The ratio of vanadium to ethylenediamine to oleic acid ratio was kept at 1:3:3 in this preparation.

Niobium carbide (NbCx) was prepared by adding 4.0 g niobic acid (Nb₂O₅ nH₂O) to 19.5 ml water, followed by the addition of 4.5 g ethylenediamine (en) solution. The niobic acid ethylenediamine solution was deposited on 20 g silica gel (SiO₂) at 100° C. using incipient wetness impregnation to 14 wt. % Nb₂O₅ loading. The impregnated silica was spread into a thin layer to dry at 100° C. overnight. Dilute 7.06 g oleic acid was added to 12.94 mL heptane and the solution was impregnated onto the silica and then dried at 100° C. The silica containing oleic acid and niobic acid was then heated at 3° C./min to 750° C. under N₂ in a tube furnace and held at 750° C. for 2 hours. Thereafter, the furnace was shut off and cooled to room temperature under N₂. The tube furnace was then purged with N₂, followed by a diluted stream of O2 in He before samples were extracted. The ratio of niobium to ethylenediamine to oleic acid ratio was kept at 1:3:1 in this preparation.

Tungsten carbide (WCx) was prepared by adding 6.25 g tungstic acid (H₂WO₄) to 25.5 ml water, followed by the addition of 4.5 ethylenediamine (en) solution. The tungstic acid ethylenediamine solution was deposited on 25 g silica gel (SiO₂) at 100° C., a using incipient wetness impregnation to 18.8 wt. % WO₃ loading. The impregnated silica was spread into a thin layer to dry at 100° C. overnight. Dilute 7.06 g oleic acid was added to 18 mL heptane and the solution was impregnated onto the silica and then dried at 100° C. and then dry again at 100° C. The silica containing oleic acid and tungstic acid was heated at 3° C./min to 750° C. under N₂ in a tube furnace and held at 750° C. for 2 hours. Thereafter, the furnace was shut off and cooled to room temperature under N₂. The tube furnace was then purged with N₂, followed by a diluted stream of O₂ in He before samples were extracted. The ratio of tungsten to ethylenediamine to oleic acid ratio was kept at 1:1:3 in this preparation.

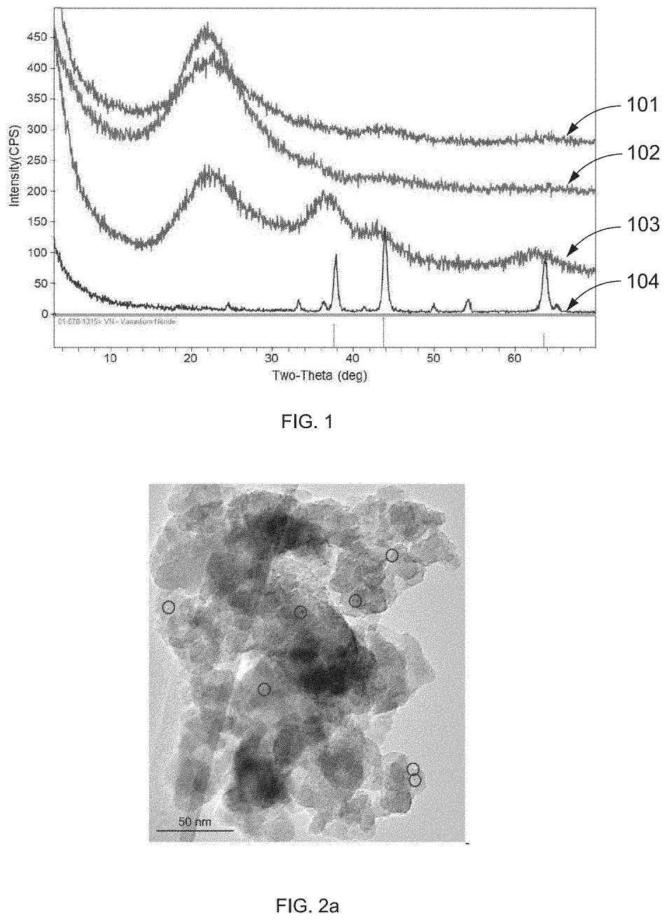

The VCx, NbCx, and WCx were subjected to x-ray diffraction (XRD) testing. The results of the XRD are shown in FIG. 1. Curve 101 corresponds to VCx, curve 102 corresponds to NbCx, curve 103 corresponds to WCx, and curve 104 corresponds to a reference VN/VC (vanadium nitride/vanadium carbide) pattern made with ethylenediamine and oleic acid. It can be observed from FIG. 1 that the each of the curves 101, 102, and 103 are wide indicating eta carbide phases that were formed are relatively small in size and well dispersed across the silica gel support. Curves 101, 102, and 103 are from Example 1 and curve 104 was derived from a standard VN/VC curve.

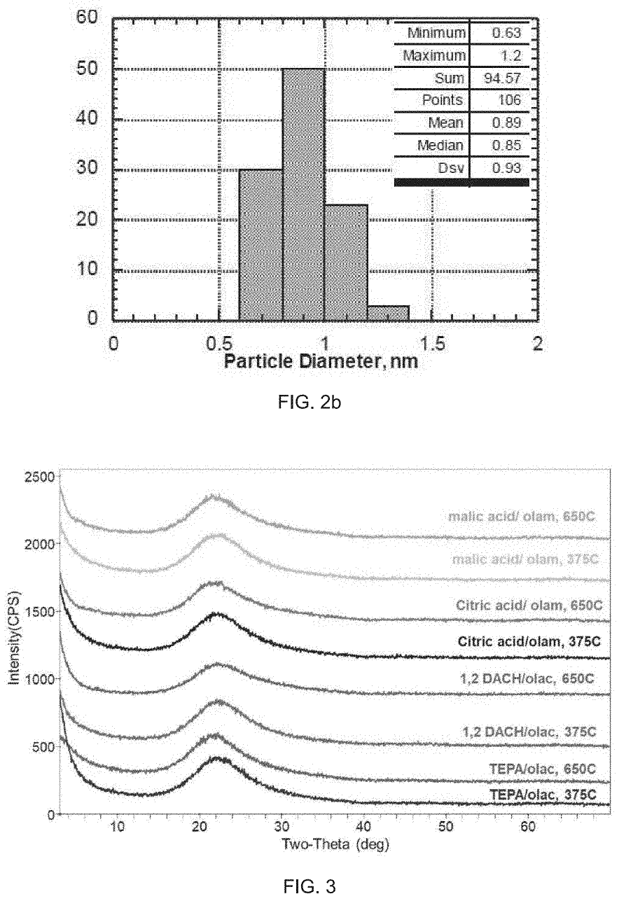

FIG. 2a is a transmission electron micrograph of the vanadium carbide. It can be observed from FIG. 2 that the vanadium carbide particles produced are on the order of nanometers. FIG. 2b is a graph of particle size distribution of the vanadium carbide XRD of FIG. 2a. It was observed that the smallest particle detected was 0.63 nm, the largest 1.2 nm, and the average 0.89 nm.

### Example 2

In this example, vanadium carbide was prepared by replacing ethylenediamine (en) for other organics. The vanadium carbides were prepared according to Table 1.

TABLE 1

| | Composition | Temperature (° C.) |
|---|---|---|
| Sample 1 | Malic Acid/Oleyl Amine | 650 |
| Sample 2 | Malic Acid/Oleyl Amine | 375 |
| Sample 3 | Citric Acid/Oleyl Amine | 650 |
| Sample 4 | Citric Acid/Oleyl Amine | 375 |
| Sample 5 | 1,2 DAHC/Oleic Acid | 350 |
| Sample 6 | 1,2 DAHC/Oleic Acid | 375 |
| Sample 7 | TEPA/Oleic Acid | 650 |
| Sample 8 | TEPA/Oleic Acid | 375 |

Vanadium carbides were prepared by adding vanadium oxide to water followed by the addition of malic acid or citric acid which was then impregnated on silica gel by incipient wetness. Thereafter, oleyl amine, 1,2 diamine cyclohexane (1,2 DACH), tetraethylenepentamine (TEPA), or oleic acid was impregnated on the silica gel. All prepared samples were heated in a tube furnace under N₂ at temperatures ranging from 375° C. to 650° C. Thereafter, the furnace was shut off and cooled to room temperature under N₂. The tube furnace was then purged with N₂, followed by a diluted stream of O₂ in He before samples were extracted. For each of the samples, the vanadium concentration was kept at 10.19 wt. % V₂O₅ on SiO₂.

Each of the samples was subjected to XRD analysis. The results of the XRD analysis are shown in FIG. 3. It can be observed that there is not a significant change in the XRD pattern of vanadium carbides prepared in Example 2 as compared to Example 1. None of the samples in FIG. 3 exhibit XRD peaks consistent with bulk VCx implying that the vanadium carbides formed are small particles (<2 nm). Further, the choice of organic compound did not appear to affect the vanadium carbides formed nor was there an increase in particle size when the temperature was reduced from 650° C. to 375° C.

### Example 3

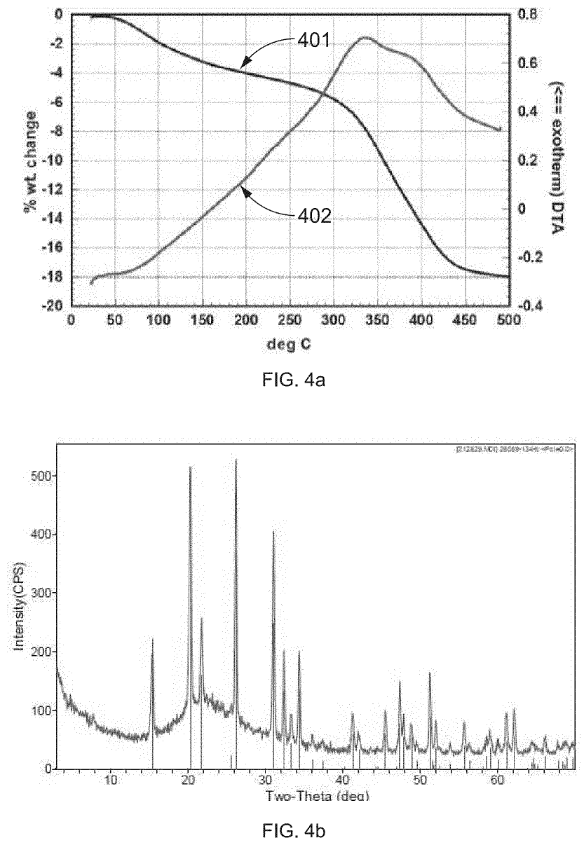

It is believed that the carbides produced in the above Examples should exhibit excellent thermal stability under N₂ or H₂ atmosphere but may be oxidized in air at elevated temperatures. In this Example, the thermal stability of the vanadium carbides prepared in Example 1 were tested by subjecting the vanadium carbides to air at elevated temperatures. The vanadium carbides were calcined in air in a thermogravimetric differential thermal analysis analyzer (TGA-DTA) up to 500° C. Thereafter, the calcined vanadium carbides we transferred to an XRD analyzer and subjected to XRD analysis. FIG. 4a is the result of the TGA-DTA analysis where curve 401 is the TGA curve and curve 402 is the DTA curve. FIG. 4b is a result of XRD analysis. It can be observed from curve 401 and the XRD data in FIG. 4b that the vanadium carbides were oxidized to bulk V₂O₅ from the well dispersed VCx precursor.

### Example 4

The following examples detail synthesis of mixed group VI and VIII eta phase carbides.

Cobalt tungsten carbide (CoWCx) was prepared by adding 2.95 g cobalt carbonate (CoCO₃) and 6.25 g tungstic acid (H₂WO₄) to 25.5 ml water, followed by the addition of either 4.5 g ethylenediamine (en) or 7.811 g 2-(2-aminoethylamino) ethanol (h-en) solution. The cobalt carbonate tungstic acid solution was deposited on 25 g of silica gel (SiO₂) at 100° C. using incipient wetness impregnation to 5.73 wt. % CoO and 17.7 wt. % WO₃ loading. The impregnated silica was spread in a thin layer to dry at 100° C. overnight. Dilute 7.06 g oleic acid was added to 18 mL heptane and the solution was impregnated on to the silica and dried dry again at 100° C. The silica with oleic acid was then heated at 3° C./min to 750° C. under N₂ in a tube furnace and held at 750° C. for 2 hours. The tube furnace was then purged with N₂, followed by a diluted stream of O₂ in He before silica was removed from the furnace. The ratio of cobalt to tungsten to ethylenediamine to oleic acid was kept at 1:1:3:1 in this preparation.

Cobalt molybdenum carbide (CoMoCx) was made by adding 2.95 g cobalt carbonate (CoCO₃) and 3.60 g molybdenum acid to 25.5 ml water, followed by the addition of 4.5 g ethylenediamine (en) solution. The cobalt carbonate molybdenum acid solution was deposited on 25 g of silica gel (SiO₂) at 100° C. using incipient wetness impregnation to 6.14 wt. % CoO and 11.8 wt. % MoO3 loading. The impregnated silica was spread in a thin layer to dry at 100° C. overnight. Dilute 7.06 g oleic acid was added to 18 mL of heptane and impregnated onto the silica then dried again at 100° C. The silica with oleic acid was then heated at 3° C./min to 750° C. under N₂ in a tube furnace and held at 750° C. for 2 hours. The tube furnace was then purged with N₂, followed by a diluted stream of O₂ in He before silica was removed from the furnace. The ratio of cobalt to molybdenum to ethylenediamine to oleic acid was kept at 1:1:3:1 in this preparation.

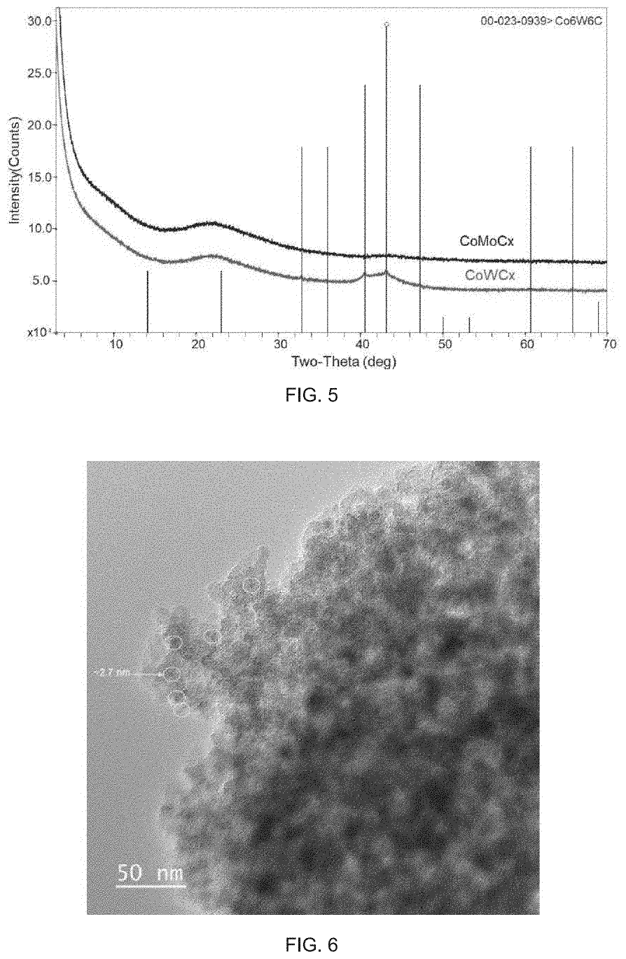

The cobalt tungsten carbide and cobalt molybdenum carbide were subjected to XRD analysis. The results of the XRD analysis are shown in FIG. 5. It can be observed that the cobalt tungsten carbide and cobalt molybdenum carbides have small and well dispersed particles.

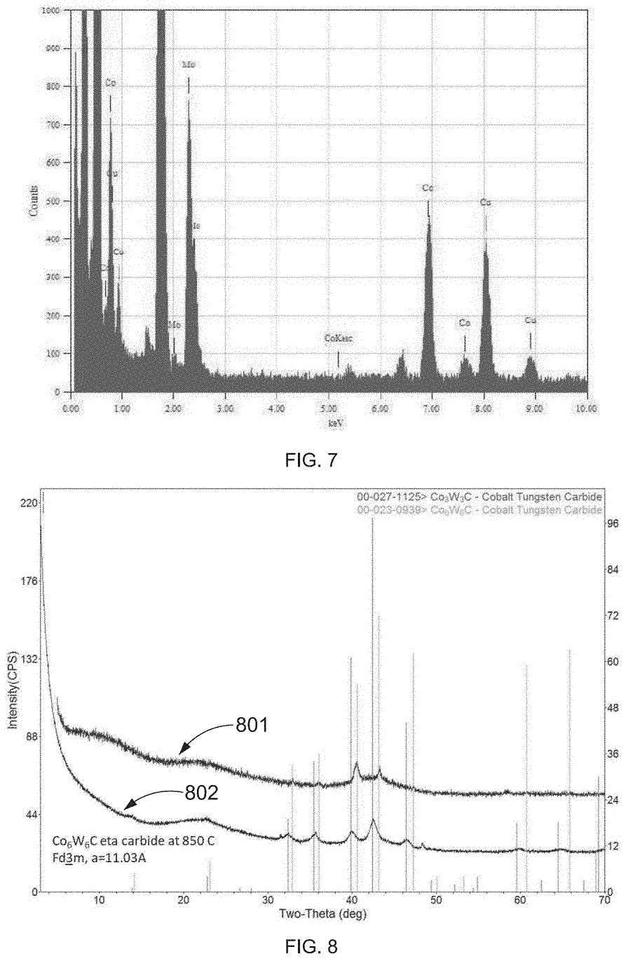

FIG. 6 is a transmission electron micrograph of the cobalt molybdenum carbide. It can be observed from FIG. 6 that the cobalt molybdenum carbide particles produced are on the order of about 1-3 nanometers and monodispresed. The cobalt molybdenum carbide was also subjected to energy-dispersive X-ray spectroscopy, the results of which are shown in FIG. 7. It can be observed from FIG. 7 that the small carbides formed contain cobalt and molybdenum.

The cobalt tungsten carbide and cobalt molybdenum carbide were subjected to elevated temperatures up to 850° C. in N₂ to test the thermal stability of the carbide phases. After heating, the cobalt tungsten carbide and cobalt molybdenum carbide were subjected to XRD analysis, the results of which are shown in FIG. 8. Curve 801 corresponds to the cobalt tungsten carbide treated at 750° C. and curve 802 corresponds to the cobalt tungsten carbide treated at 850° C. It can be observed that the cobalt tungsten carbide and cobalt molybdenum carbide phases are stable up to 850° C. without sintering the individual particles of cobalt tungsten carbide and cobalt molybdenum carbide. It can further be observed that the lattice structure of cobalt tungsten carbide and cobalt molybdenum carbide shift to higher d spacing meaning the carbide framework expands with temperature. The lattice spacing of cobalt tungsten carbide and cobalt molybdenum carbide may be tuned with heat treatment.

### Example 5

Cobalt nickel tungsten carbide (Co.99Ni.01WCx) (stoichiometric notation) was prepared by adding 2.92 g cobalt carbonate, 0.03 g nickel carbonate, and 6.25 g tungstic acid to 25.5 ml water, followed by the addition of 4.5 g ethylenediamine (en) solution. The cobalt carbonate nickel carbonate tungstic acid solution was deposited on 25 g of silica gel (SiO₂) at 100° C. using incipient wetness impregnation to 5.73 wt. % CoO, 1 wt. % NiO, and 17.7 wt. % WO₃ loading. The impregnated silica was spread in a thin layer to dry at 100° C. overnight. Dilute 7.06 g oleic acid was added to 18 mL heptane and impregnated onto the silica then dried again at 100° C. The silica with oleic acid was then heated at 3° C./min to 750° C. under N₂ in a tube furnace and held at 750° C. for 2 hours. The tube furnace was then purged with N₂, followed by a diluted stream of O₂ in He before silica was removed from the furnace. The cobalt to tungsten to ethylenediamine to oleic acid ratio was kept at 1:1:3:1 in this preparation.

Cobalt nickel tungsten carbide (Co.95Ni.05WCx) (stoichiometric notation) was prepared by adding 2.8 g cobalt carbonate, 0.15 g nickel carbonate, and 6.25 g tungstic acid to 25.5 ml water, followed by the addition of 4.5 g ethylenediamine (en) solution. The cobalt carbonate nickel carbonate tungstic acid solution was deposited on 25 g of silica gel (SiO₂) at 100° C. using incipient wetness impregnation to 5.73 wt. % CoO, 5 wt. % NiO, and 17.7 wt. % WO₃ loading. The impregnated silica was spread in a thin layer to dry at 100° C. overnight. Dilute 7.06 g oleic acid was added to 18 mL heptane and impregnated onto the silica then dried again at 100° C. The silica with oleic acid was then heated at 3° C./min to 750° C. under N₂ in a tube furnace and held at 750° C. for 2 hours. The tube furnace was then purged with N₂, followed by a diluted stream of O₂ in He before silica was removed from the furnace. The cobalt to tungsten to ethylenediamine to oleic acid ratio was kept at 1:1:3:1 in this preparation.

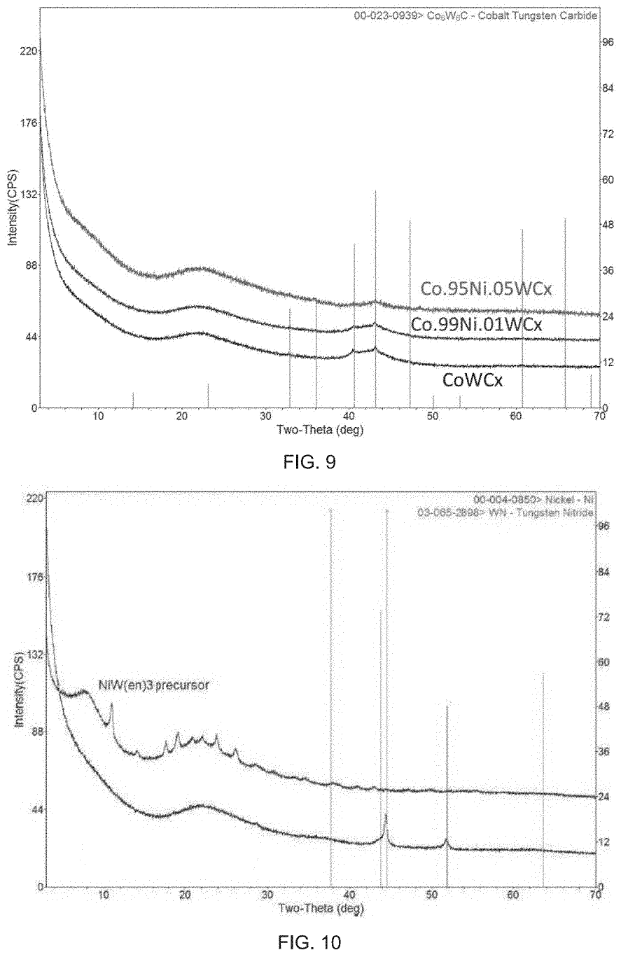

The Co.99Ni.01WCx and Co.95Ni.05WCx were subjected to XRD analysis. The results of the XRD analysis are shown in FIG. 9. In FIG. 9, CoWCx from Example 4 is included as reference. It can be observed that the Cobalt nickel tungsten carbides have small and well dispersed particles. Further, it can be observed that with the incorporation of more nickel, the carbide phase becomes more amorphous.

### Example 6

Nickel tungsten carbide (NiWCx) was first attempted to be prepared similarly to CoWCx by adding 2.95 g nickel carbonate and 6.25 g tungstic acid to 25.5 ml water, followed by the addition of 4.5 g ethylenediamine (en) solution. The cobalt carbonate nickel carbonate tungstic acid solution was deposited on 25 g of silica gel (SiO₂) at 100° C. using incipient wetness impregnation to 5.73 wt. % NiO and 17.7 wt. % WO3 loading. The impregnated silica was spread in a thin layer to dry at 100° C. overnight. Dilute 7.06 g oleic acid was added to 18 mL of heptane and impregnated onto the silica then dried again at 100° C. The silica with oleic acid was then heated at 3° C./min to 750° C. under N₂ in a tube furnace and held at 750° C. for 2 hours. The tube furnace was then purged with N₂, followed by a diluted stream of O₂ in He before silica was removed from the furnace. Nickel to tungsten to ethylenediamine to oleic acid ratio was kept at 1:1:3:1 in this preparation.

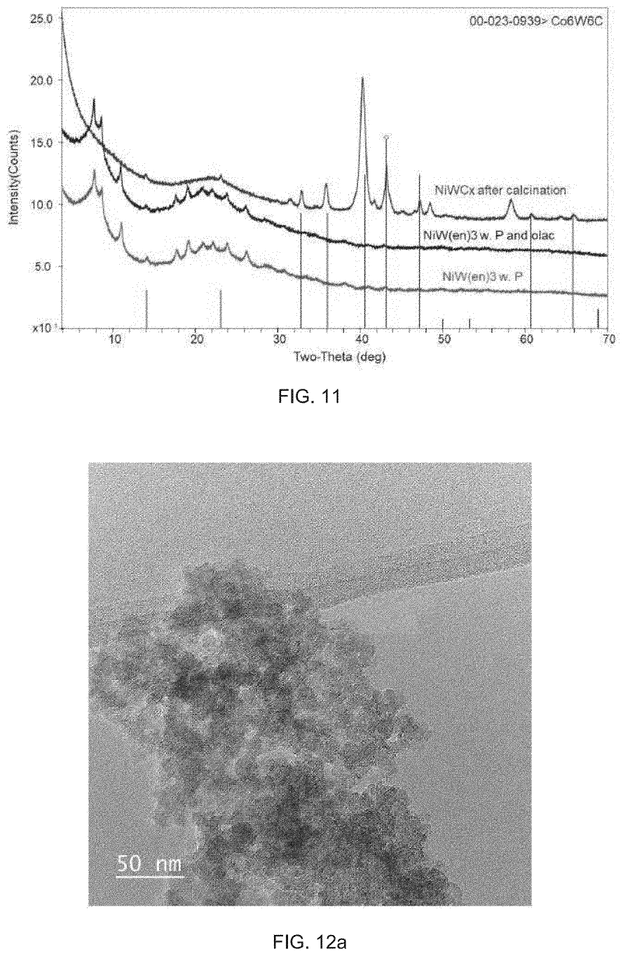

The prepared nickel tungsten carbide was subjected to XRD analysis, the results of which are shown in FIG. 10. It can be observed from FIG. 10 that the preparation of the nickel tungsten carbide was unsuccessful as after the nickel tungsten carbide precursor was subjected to 750° C. the nickel phase separated from the WCx phase. The nickel tungsten carbide preparation was attempted again with the inclusion of hydrophosphorous to keep the nickel and tungsten phases intact to form a single NiWCx phase. The Nickel tungsten carbide (NiWCx) was successfully prepared by adding 2.21 g nickel carbonate and 4.69 g tungstic acid to 17 ml water, followed by the addition of 3.38 g ethylenediamine (en) solution and 0.74 g hydrophosphorous solution. The cobalt carbonate nickel carbonate tungstic acid solution was deposited on 25 g of silica gel (SiO₂) at 100° C. using incipient wetness impregnation to 5.73 wt. % NiO and 17.7 wt. % WO3 loading. The impregnated silica was spread in a thin layer to dry at 100° C. overnight. Dilute 5.29 g oleic acid was added to 19.8 mL of heptane and impregnated onto the silica then dried again at 100° C. The silica with oleic acid was then heated at 3° C./min to 750° C. under N₂ in a tube furnace and held at 750° C. for 2 hours. The tube furnace was then purged with N₂, followed by a diluted stream of O₂ in He (to passivate) before silica was removed from the furnace. Nickel to tungsten to ethylenediamine to H₃PO₂ to oleic acid ratio was kept at 1:1:3:0.3:1 in this preparation.

The prepared nickel tungsten carbide was subjected to XRD analysis, the results of which are shown in FIG. 11. It can be observed from FIG. 11 that the preparation of the nickel tungsten carbide was successful by inclusion of the phosphorous and oleic acid.

### Example 7

In this example selected carbides were evaluated for hydroprocessing (HDP) applications. CoMoCx, CoWCx and NiWCx were tested to evaluate their HDP activity using heavy tail end straight run diesel. Each of the carbides was sulfided in situ to the active sulfided form. The run conditions and results of the HDP testing are shown in Tables 2.1 and 2.2 below. It was observed that CoMoCx has the best performance with about 94.7% sulfur conversion and about 62.9% nitrogen conversion at process conditions of 600 psig, temperature of 335° C., liquid hourly space velocity (LHSV) 0.5 hours⁻¹, and treat gas rate (TGR) of 1000 standard cubic feet per barrel (scf/bbl). The relative volume activity (RVA) of CoMoCx to CoWCx at 600 psig (pounds per square inch gauge) was observed to be 2.02 and at 300 psig RVA was observed to be 1.92. The RVA of CoMoCx to NiWCx at 600 psig was observed to be 1.81 and at 300 psig RVA was observed to be 1.84.

TABLE 2.1

| Feed | Straight Run Diesel | | |
|---|---|---|---|
| Process | 600 psig H2 | | |
| Pressure | | | |
| Process | 335° C. | | |
| Temperature | | | |
| TGR/LHSV | 1000/0.5 | | |
| Catalyst | CoMoCx | CoWCx | NiWCx |
| Product S | 531 ppm/94.7% | 1712 ppm/82.9% | 1458 ppm/85.5% |
| Conversion | | | |
| Product N | 69 ppm/62.9% | 125 ppm/32.8% | 113 ppm/39.2% |
| conversion | | | |

TABLE 2.2

| Feed | Straight Run Diesel | | |
|---|---|---|---|
| Process | 300 psig H2 | | |
| Pressure | | | |
| Process | 335° C. | | |
| Temperature | | | |
| TGR/LHSV | 1000/0.5 | | |
| Catalyst | CoMoCx | CoWCx | NiWCx |
| Product S | 658 ppm/93.4% | 1861 ppm/81.4% | 1756 ppm/82.5% |
| Conversion | | | |
| Product N | 136 ppm/26.9% | 161 ppm/13.4% | 159 ppm/14.5% |
| conversion | | | |

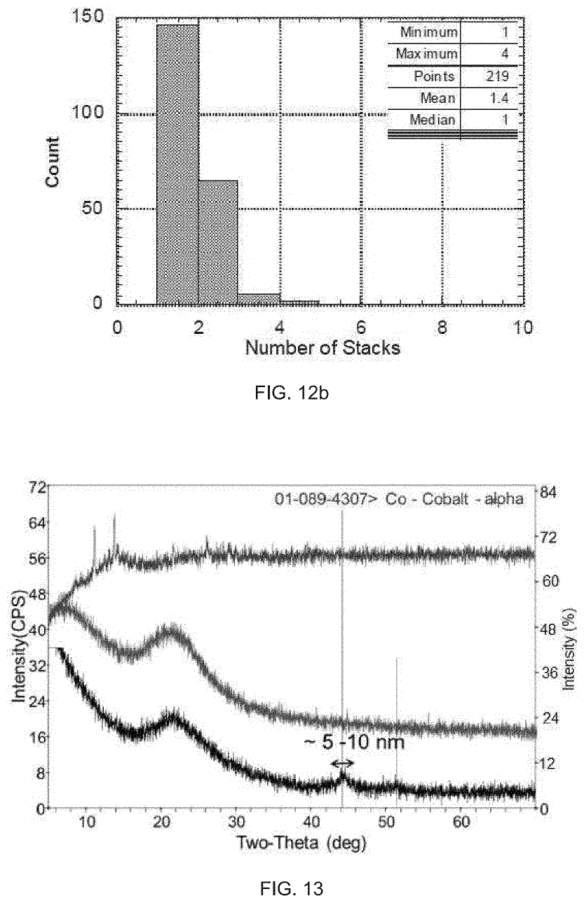

After the HDP testing, the CoMoCx catalyst was removed from the HDP reactor and subjected to transmission electron microscopy, the results of which are shown in FIGS. 12a and 12b. It can be observed from FIGS. 12a and 12b that the CoMoCx catalyst has a majority of the sulfides as single stack layers.

### Example 8

In this Example synthesis of group VIII carbides was performed. CoCx was attempted to be prepared by adding 2.95 g cobalt carbonate to 25.5 ml water, followed by the addition of 4.5 g ethylenediamine (en) solution. The cobalt carbonate solution was deposited on 25 g silica gel (SiO₂) at 100° C. using incipient wetness impregnation. The impregnated silica was spread in a thin layer to dry at 100° C. overnight. Dilute 7.06 g oleic acid was added to 18 mL heptane and impregnated onto the silica then dried again at 100° C. Samples with oleic acid were then heated at 3° C./min to 375° C., or 625° C., or 650° C. under N₂ in a tube furnace and held at the selected temperature for 2 hours. The tube furnace was then purged with N₂, followed by a diluted stream of O₂ in He before silica was removed from the furnace. The cobalt to ethylenediamine to oleic acid was kept at 1:3:1 in this preparation.

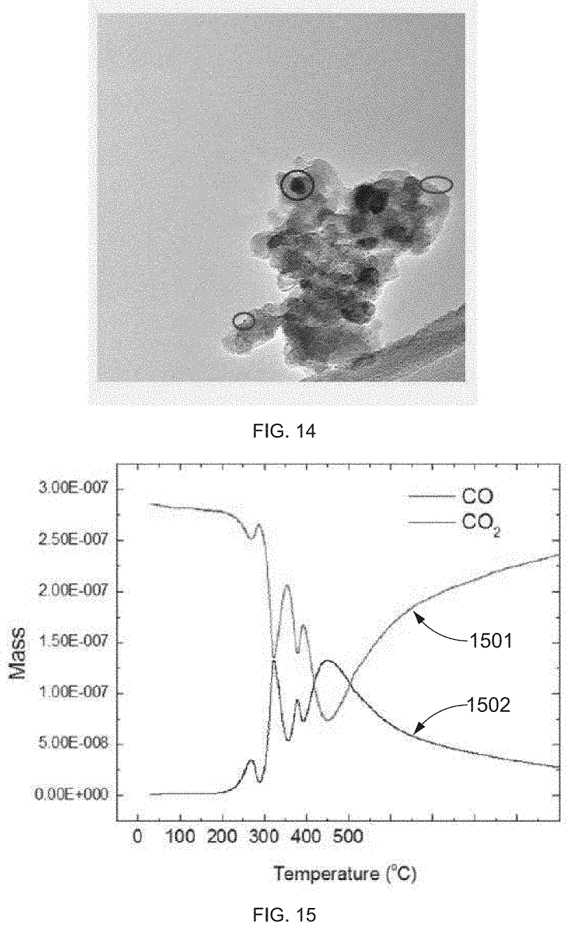

The prepared cobalt carbide was subjected to XRD analysis, the results of which are shown in FIG. 13. The prepared cobalt carbide was further subjected to transmission electron microscopy, the results of which are shown in FIG. 14. It can be observed from FIG. 13 and FIG. 14 that the preparation the carbide was unsuccessful yielding only cobalt metal. It can be o

The stability of CoCx was explored using carbon monoxide titration. FIG. 15 is a titration curve of carbon monoxide. Curve 1501 corresponds to carbon monoxide and curve 1502 corresponds to carbon dioxide. It can be observed in FIG. 15 that the cobalt carbide (Co₂C) exists in a narrow temperature range and lower temperatures are likely to yield a mixture of CoO and Co₂C and higher temperatures are likely to yield Co₂C and Co metal. It can be further observed that there are three stages of carbon monoxide consumption 1) 230° C. Co₃O₄ to CoO, 2) 280° C. CoO to CoCx, 3) 375-510° C. CoCx to Co.

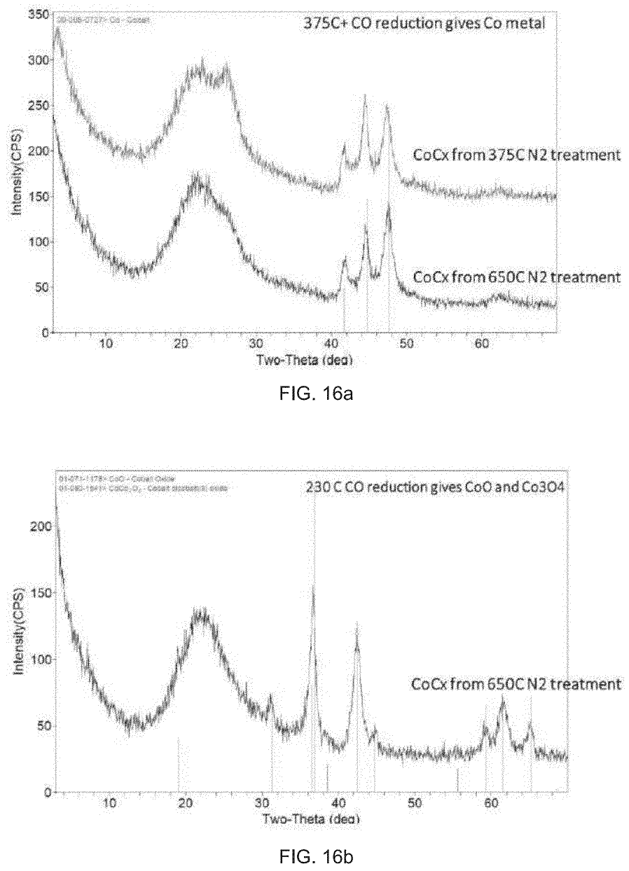

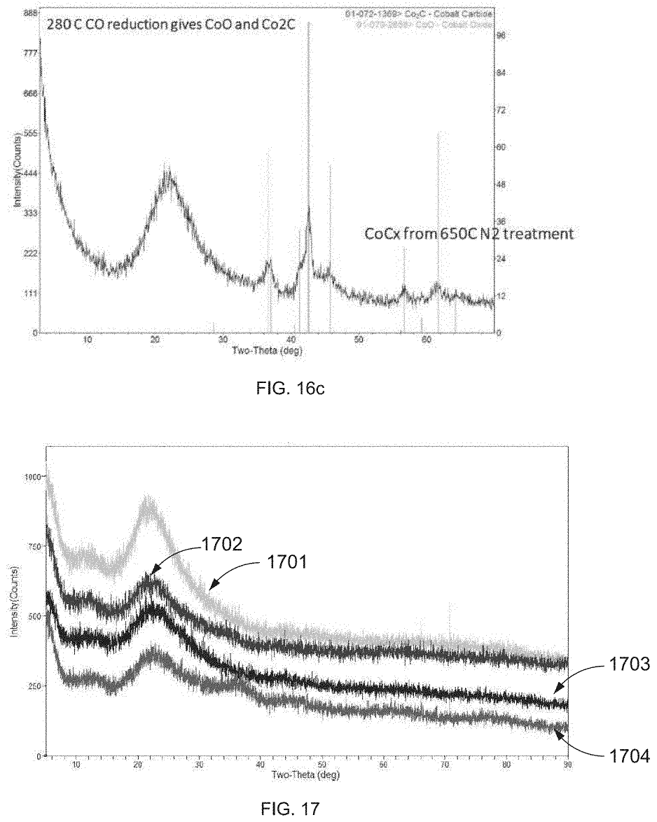

The carbides from the carbon monoxide titration were subjected to XRD analysis, the results of which are shown in FIG. 16a, FIG. 16b, and FIG. 16c. The results in FIGS. 16 a, b, and c confirm that there are three stages of CoCx reduction and that CoCx can be obtained at 280° C.

### Example 9

Vanadium tungsten carbide (VWCx) was prepared by adding 6.82 g vanadium oxide, 6.24 g tungstic acid, and 18.03 g ethylenediamine to 30 ml water. The vanadium oxide tungstic acid solution was deposited on 40 g silica gel (SiO₂) at 100° C. using incipient wetness impregnation to 13 wt. % V₂O₅ and 11.0 wt. % WO₃ loading. The impregnated silica was spread in a thin layer to dry at 100° C. overnight. Dilute 28.25 g oleic acid was added to 11.75 mL heptane and impregnated onto the silica then dried again at 100° C. Samples with oleic acid were then heated at 3° C./min to 625° C. under N₂ in the tube furnace and held at 625° C. for 2 hours. The tube furnace was then purged with N₂, followed by a diluted stream of O₂ in He before silica was removed from the furnace. The vanadium to tungsten to ethylenediamine to oleic acid ratio was kept at 0.75:0.25:3:1 in this preparation. In separate preparations, ratios such as 0.5:0.5:3:1, 0.5:0.5:3:0, 0.25:0.75:3:1, 0.25:0.75:3:0 were also successfully made. Co and Ni substitution were also attempted but even up to 10% solutions led to precipitation prior to incipient wetness impregnation.

Vanadium molybdenum carbide (VMoCx) was prepared by adding 4.54 g vanadium oxide, 4.19 g molybdenum acid, and 18.03 g ethylenediamine to 30 ml water. The vanadium oxide molybdenum acid solution was deposited on 40 g silica gel (SiO₂) at 100° C. using incipient wetness impregnation to 8.8 wt. % V₂O₅ and 13.9 wt. % MoO₃ loading. The impregnated silica was spread in a thin layer to dry at 100° C. overnight. Dilute 28.25 g oleic acid was added to 11.75 mL heptane and impregnated onto the silica and then dry again at 100° C. Samples with oleic acid were then heated at 3° C./min to 625° C. under N₂ in the tube furnace and held at 625° C. for 2 hours The tube furnace was then purged with N₂, followed by a diluted stream of O₂ in He before silica was removed from the furnace. The vanadium to molybdenum to ethylenediamine to oleic acid ratio was kept at 0.5:0.5:3:1 in this preparation.

Vanadium manganese carbide (VMnCx) was prepared by adding 4.54 g vanadium oxide, 9.85 g manganese oxide, and 26.8 g malic acid to 30 ml water. The vanadium oxide manganese oxide solution was deposited on 40 g silica gel (SiO₂) at 100° C. using incipient wetness impregnation to 9.4 wt. % V₂O₅ and 6.1 wt. % MnO₂ loading. The impregnated silica was spread in a thin layer to dry at 100° C. overnight. Dilute 24.75 g oleyl amine was added to 15.25 mL heptane and impregnated onto the above product, then dried again at 100° C. Samples with oleic acid were then heated at 3° C./min to 625° C. under N2 in the tube furnace and held at 625° C. for 2 hours. The tube furnace was then purged with N₂, followed by a diluted stream of O₂ in He before silica was removed from the furnace. The vanadium to manganese to malic acid to oleyl amine was kept at 0.5:0.5:3:1 in this preparation.

Vanadium niobium carbide (VNbCx) was made by adding 1.13 g vanadium oxide, 1.99 g niobic acid, and 4.5 g ethylenediamine to 7.5 ml water. The vanadium oxide niobic acid solution was deposited on 10 g silica gel (SiO₂) at 100° C. using incipient wetness impregnation to 8.9 wt. % V₂O₅ and 12.5 wt. % Nb₂O₅ loading. The impregnated silica was spread in a thin layer to dry at 100° C. overnight. Dilute 7.06 g oleic acid was added to 3 mL heptane and impregnated onto the above product, then dried again at 100° C. Samples with oleic acid were then heated at 3° C./min to 625° C. under N₂ in the tube furnace and held at 625° C. for 2 hours. The tube furnace was then purged with N₂, followed by a diluted stream of O₂ in He before silica was removed from the furnace. The vanadium to niobium to ethylendiamine to oleic acid ratio was kept at 0.5:0.5:3:1 in this preparation. The prepared carbides were subjected to XRD analysis, the results of which are shown in FIG. 17. In FIG. 17, curve 1701 is VNbCx, curve 1702 is VMnCx, curve 1703 us VMoCx, and curve 1704 is VWCx.

While the invention has been described with respect to a number of embodiments and examples, those skilled in the art, having benefit of this disclosure, will appreciate that other embodiments can be devised which do not depart from the scope and spirit of the invention as disclosed herein. Although individual embodiments are discussed, the invention covers all combinations of all those embodiments.

While compositions, methods, and processes are described herein in terms of “comprising,” “containing,” “having,” or “including” various components or steps, the compositions and methods can also “consist essentially of” or “consist of” the various components and steps. The phrases, unless otherwise specified, “consists essentially of” and “consisting essentially of” do not exclude the presence of other steps, elements, or materials, whether or not, specifically mentioned in this specification, so long as such steps, elements, or materials, do not affect the basic and novel characteristics of the invention, additionally, they do not exclude impurities and variances normally associated with the elements and materials used.

All numerical values within the detailed description and the claims herein modified by “about” or “approximately” with respect the indicated value are intended to take into account experimental error and variations that would be expected by a person having ordinary skill in the art.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited.

1. A method of producing a carbide catalyst comprising:
depositing a precursor metal, an acid and/or an amine, and an organic compound on a support thereby forming an impregnated support, wherein the organic compound has a carbon number of 10 or greater; and
carbonizing the impregnated support thereby forming a carbide phase on the support.

2. The method of claim 1, wherein the precursor metal is selected from the group consisting of a group V metal, a group VI metal, a group VII metal, a group VIII metal, nickel, cobalt, and combinations thereof.

3. The method of claim 1, wherein the precursor metal is at least one of vanadium oxide (V₂O₅), manganese oxide (MnO, Mn₃O₄, Mn₂O₃), niobium pentoxide (Nb₂O₅), niobic acid (Nb₂O₅.nH₂O), tungsten oxide (W₂O₃, WO₂, WO₃, W₂O₅), tungstic acid monohydrate (WO₃.H₂O), tungstic acid hemihydrate (WO₃.0.5H₂O), ammonium metatungstate hydrate ((NH₄)₆H₂W₁₂O₄₀ xH₂O), molybdenum trioxide (MoO₃), molybdenum acid monohydrate (MoO₃.H₂O), molybdenum acid monohydrate dihydrate (MoO₃.2H₂O), or combinations thereof.

4. The method of claim 1, wherein the precursor metal comprises a first metal selected from a group VI metal or a group VIII metal and a second metal selected from cobalt or nickel and wherein the carbide phase formed comprises eta carbide.

5. The method of claim 4, wherein the eta carbide phase comprises particles of eta carbide, wherein 50 wt. % or greater of the particles of eta carbide comprise particle sizes of less than 2 nm, and wherein 50% or more of the particles of eta carbide are monodispersed.

6. The method of claim 1, wherein the carbide catalyst is a bimetallic carbide of the form of (M₁M₂Cx) where M₁ and M₂ are metals are individually selected from group V, VI, VII, and VIII and Cx is carbon wherein M₁ and M₂ are present in a molar ratio of about 0.5:1 to about 1:1.

7. The method of claim 1, wherein the acid or amine is selected from the group consisting of ethylenediamine, citric acid, malic acid, 2-(2-aminoethylamino) ethanol, 1,2 diamine cyclohexane, and combinations thereof.

8. The method of claim 1, wherein the organic compound comprises at least one functional group selected from the group consisting of carboxylic acid, amine, alcohol, phosphate, acrylate, ketone, and combinations thereof.

9. The method of claim 1, wherein the organic compound is a long chain fatty acid or fatty amine with carbon numbers from C10 to C24.

10. The method of claim 1, wherein the support is selected from the group consisting of silica (SiO₂), alumina (Al₂O₃), aluminosilicates, magnesia, titania, tungsten oxide (WO3), zirconium oxide (ZrO₂), tungsten oxide/zirconium oxide (WO3/ZrO₂), acidic clay, silicoaluminophosphates (SAPO), and combinations thereof.

11. The method of claim 1, wherein the step of depositing comprises depositing using incipient wetness.

12. The method of claim 1, wherein the step of carbonizing comprises heating the impregnated support at a temperature in a range of about 350° C. to about 1000° C. in an inert atmosphere.

13. The method of claim 12, wherein the inert atmosphere is free of methane, CO, and C02.

14. A method comprising:
dissolving a first metal selected from group VI or group VIII and a second metal selected from cobalt or nickel in an acid or an amine to form a metal solution;
depositing the metal solution on a support;
depositing an organic compound on the support, wherein the organic compound has a carbon number of 10 or greater; and
carbonizing the support thereby forming a carbide phase on the support.

15. The method of claim 14, wherein the acid or amine at least partially chelate the first metal, the second metal, or both.

16. The method of claim 14, wherein the acid or amine is selected from the group consisting of ethylenediamine, citric acid, malic acid, 2-(2-aminoethylamino) ethanol, 1,2 diamine cyclohexane, and combinations thereof.

17. The method of claim 14, wherein the organic compound comprises at least one functional group selected from the group consisting of carboxylic acid, amine, alcohol, phosphate, acrylate, ketone, and combinations thereof and wherein the organic compound has a carbon number from C10 to C24.

18. A method of preparing nickel tungsten carbide comprising:
depositing nickel carbonate, tunstic acid, ethylenediamine, hydrophosphorous, and an organic compound with a carbon number of 10 or greater on a support forming an impregnated support; and
carbonizing the impregnated support thereby forming a nickel tungsten carbide phase on the support.

19. The method of claim 18, wherein the organic compound comprises at least one functional group selected from the group consisting of carboxylic acid, amine, alcohol, phosphate, acrylate, ketone, and combinations thereof and wherein the organic compound has a carbon number from C10 to C24.

20. A method comprising:
providing a reactor comprising a carbide catalyst, wherein the carbide catalyst comprises eta carbide;
contacting the carbide catalyst with a sulfiding compound effective to covert the eta carbide to an active sulfided form thereby forming a sulfided catalyst;
contacting a feed comprising nitrogen compounds, sulfur compounds, or both and a hydrogen feed with the sulfided catalyst at effective hydroprocessing conditions; and
reacting at least a portion of the nitrogen compounds, sulfur compounds, or both with the hydrogen.

21. The method of claim 20, wherein the carbide catalyst comprises eta phase carbide particulates disposed on a support, wherein 50 wt. % or greater of the particles eta phase carbide comprise particle sizes of less than 2 nm, and wherein 50% or more of the eta phase carbide are monodispersed.

22. The method of claim 20, wherein the carbide catalyst comprises a first metal selected from a group VI metal or a group VIII metal and a second metal selected from cobalt or nickel.
